(19) United States
(12) Patent Application Publication
(10) Pub. No.: US 2008/0146319 A1
(43) Pub. Date: Jun. 19, 2008

(54) SLOT MACHINE

(75) Inventor: Kazumasa YOSHIZAWA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/954,291

(22) Filed: Dec. 12, 2007

(30) Foreign Application Priority Data
Dec. 15, 2006 (JP) 2006-339043

(51) Int. Cl. A63F 13/00; G07F 17/32

(52) U.S. Cl. 463/21

(57) ABSTRACT

The present invention provides a slot machine in which, when symbols of the same kind are stopped and displayed on a plurality of reels adjacent to each other, a new reel is formed by combining the plurality of reels, and symbols are arranged by rotating the formed reel. When a total of fifteen symbols 46 are stopped and displayed on symbol display areas 31 through 45 in a normal game, if a bonus game transfer condition is satisfied and a combination including a predetermined number or more of symbols of the same kind arranged on a plurality of reels adjacent to each other is formed, anew combined reel is formed by combining the plurality of reels adjacent to each other, and a new combined symbol is formed by combining the symbols 46 of the same kind displayed on the plurality of reels adjacent to each other, and in a subsequent bonus game, a plurality of symbols including the combined symbol are scrolled and displayed on a plurality of reels including the combined reel.

### RELATED APPLICATION

This application claims the priority of Japanese Patent Application No. 2006-339043 filed on Dec. 15, 2006, which is incorporated herein by reference.

### FIELD OF THE INVENTION

The present invention relates to a slot machine which arranges symbols by rotating reels.

### DESCRIPTION OF THE RELATED ART

Conventionally, in a slot machine as a kind of game machines, a game is started in response to insertion of game media such as coins into the game machine, and a symbol row is subjected to variable display in a predetermined area, and stopped and displayed after a predetermined time elapses, and based on a combination of the stopped symbols, a prize is awarded.

Generally, it is judged whether the combination that causes a prize to be awarded is formed based on whether a predetermined number of symbols of the same kind (for example, “CHERRY” or “7”) are aligned along a payline set in advance. There is also a conventional case where a prize is awarded based on a combination that is not along the payline.

For example, in the specification of United States Patent Publication No. 6093102A1, a slot machine is described which displays a total of 15 symbols of 3×5 by using video reels or mechanical reels. In this slot machine, when a game is started, the reels rotate and symbols in rows aligned vertically start to be variably displayed in conjunction with the reels, and after a predetermined time elapses, according to stop of the rotation of the reels, three symbols are stopped and displayed in each row. Then, when the combination of the symbols stopped and displayed includes a predetermined number or more of symbols of the same kind, a prize is awarded. There is another slot machine as described in the specification of United States Patent Publication No. 6981635B1 which is improved in entertainment by displaying an effect image using symbols across a plurality of symbol display areas when symbols of the same kind are arranged in a plurality of symbol display areas adjacent to each other.

In the conventional slot machines described above, the number and sizes of reels which perform scrolling display and stopping display of symbols are determined in advance for each game machine. The kinds and numbers of symbols to be arranged on the reels are also fixed, and these are not changed during a game. Therefore, symbols are varied repeatedly in the same pattern for every game.

An object of the invention is to provide a slot machine having high visibility and improved entertainment by changing symbols to be arranged on the reels as well as the number and sizes of reels according to game progress.

### SUMMARY OF THE INVENTION

(1) In the present invention, a slot machine includes: a controller which controls game progress; symbol display areas for displaying symbols; and a plurality of reels which perform scrolling display of a plurality of symbols and stopping display of any one or a plurality of symbols in the symbol display areas, wherein the controller forms a new combined reel by combining a plurality of reels adjacent to each other when a predetermined number or more of symbols of the same kind are stopped and displayed on the plurality of reels adjacent to each other, and scrolls and displays a plurality of symbols on a plurality of reels including the combined reel in a subsequent game.

(2) In the present invention, a slot machine includes: a controller which controls game progress; symbol display areas for displaying symbols; and a plurality of reels which perform scrolling display of a plurality of symbols and stopping display of any one or a plurality of symbols in the symbol display areas, wherein the controller forms a new combined reel by combining a plurality of reels adjacent to each other when a predetermined number or more of symbols of the same kind are stopped and displayed on the plurality of reels adjacent to each other, forms a new combined symbol by combining the predetermined number or more of symbols of the same kind stopped and displayed, and scrolls and displays a plurality of symbols including the combined symbol on a plurality of reels including the combined reel in a subsequent game.

(3) In the present invention, a slot machine includes: a controller which controls game progress; symbol display areas for displaying symbols; and a plurality of reels which perform scrolling display of a plurality of symbols and stopping display of any one or a plurality of symbols in the symbol display areas, wherein the controller executes a bonus game continuously from a normal game when a predetermined bonus game transfer condition is satisfied, forms a new combined reel by combining a plurality of reels adjacent to each other when the bonus game transfer condition is satisfied and a predetermined number or more of symbols of the same kind are stopped and displayed on the plurality of reels adjacent to each other, forms a new combined symbol by combining the predetermined number or more of symbols of the same kind stopped and displayed, and scrolls and displays a plurality of symbols including the combined symbol on a plurality of reels including the combined reel in a subsequent bonus game.

(4) In the present invention, in the slot machine according to (1) described above, the controller executes a bonus game continuously from a normal game when a predetermined bonus game transfer condition is satisfied, forms a new combined reel by combining a plurality of reels adjacent to each other when the bonus game transfer condition is satisfied and a predetermined number or more of symbols of the same kind are stopped and displayed on the plurality of reels adjacent to each other, and scrolls and displays a plurality of symbols on a plurality of reels including the combined reel in a subsequent bonus game.

In the slot machine of the present invention, when a predetermined number or more of symbols of the same kind are stopped and displayed on a plurality of reels adjacent to each other, a new combined reel is formed by combining the plurality of reels adjacent to each other, and a plurality of symbols are scrolled and displayed on a plurality of reels including the combined reel in a subsequent game, so that by changing the number and sizes of reels according to the progress of the game, the entertainment of the slot machine can be improved while securing high visibility.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

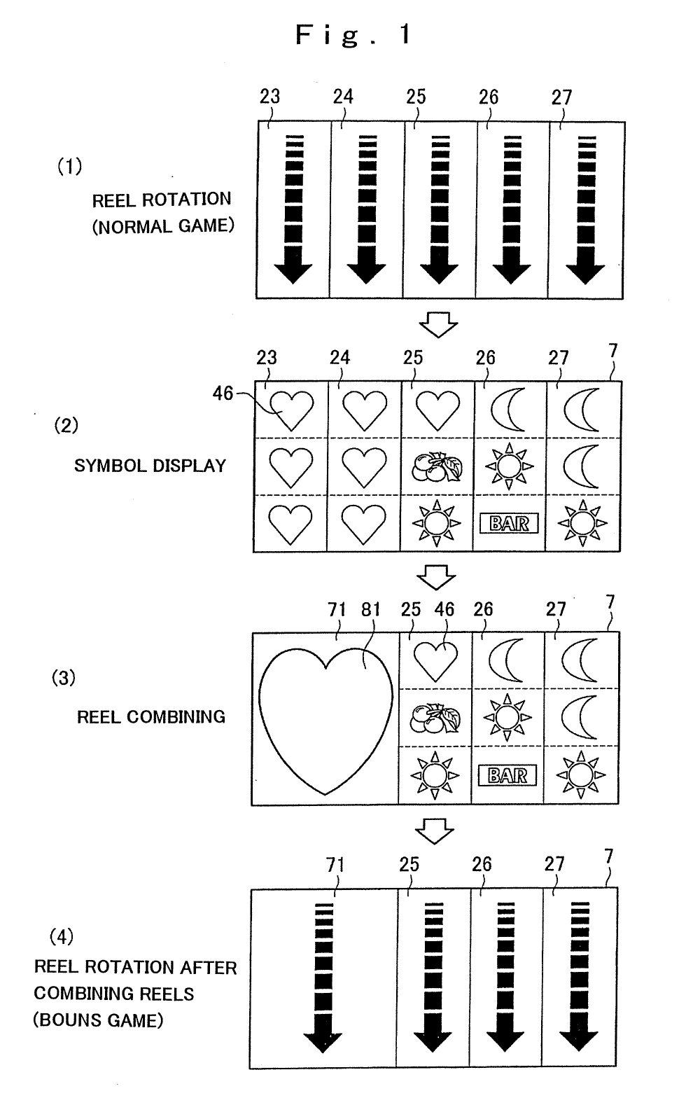

FIG. 1 are drawings showing an example of a combining pattern of reels in a slot machine of this embodiment;

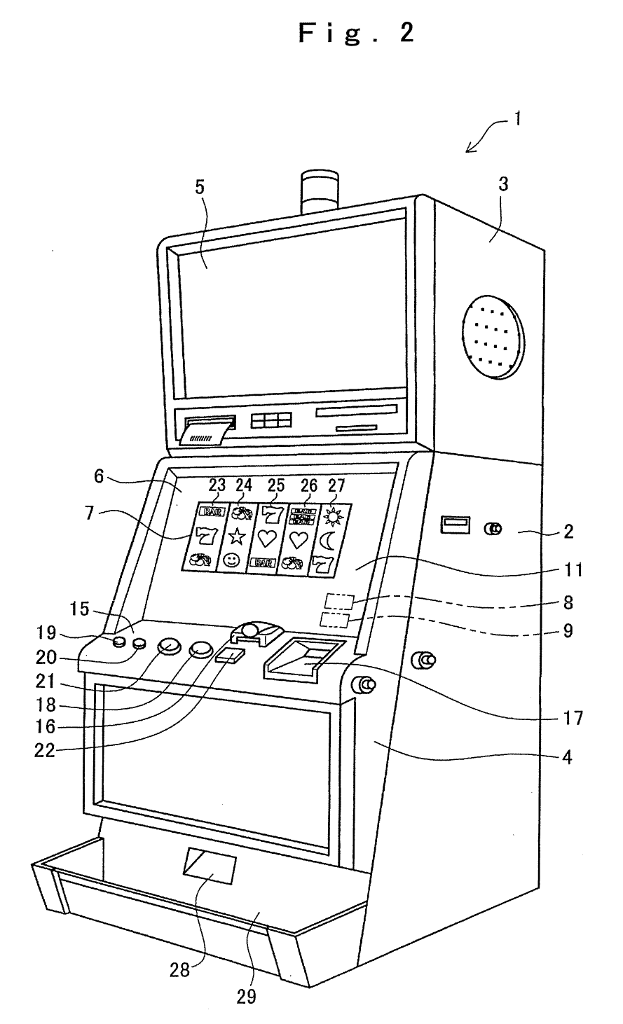

FIG. 2 is a perspective view showing an external appearance of the slot machine of this embodiment;

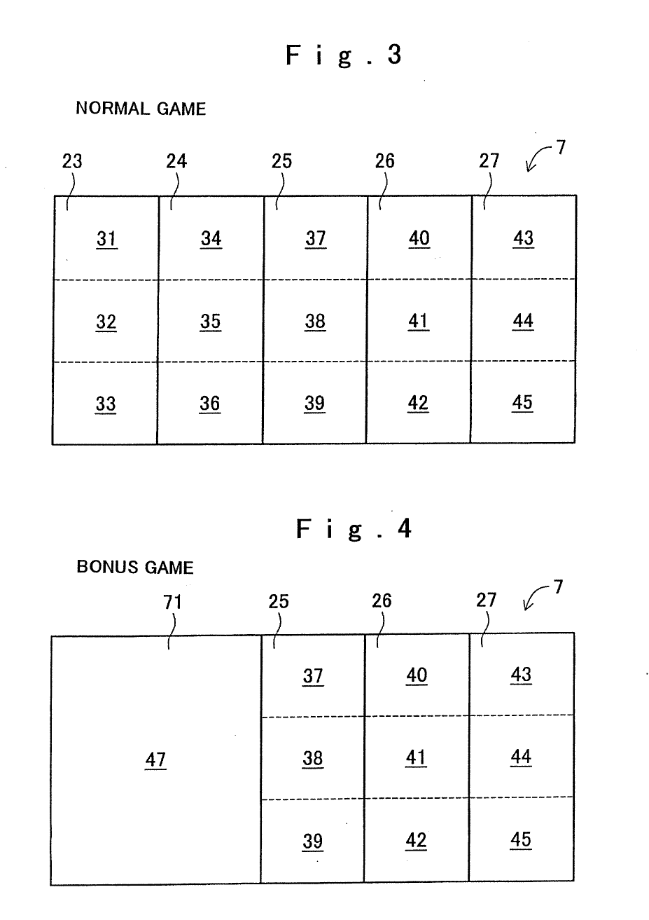

FIG. 3 is a front view showing a symbol display unit when executing a normal game in the slot machine of this embodiment;

FIG. 4 is a front view showing the symbol display unit when executing a bonus game in the slot machine of this embodiment;

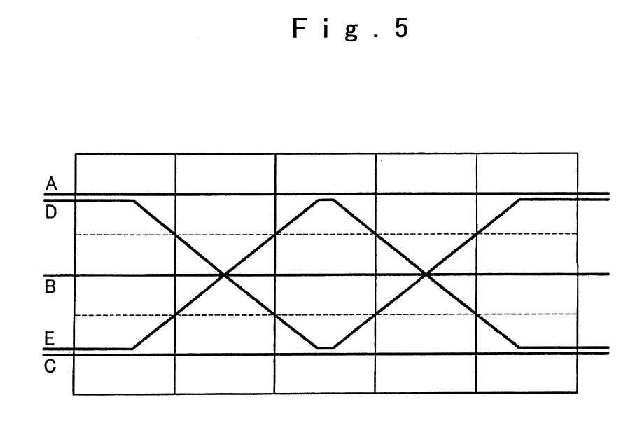

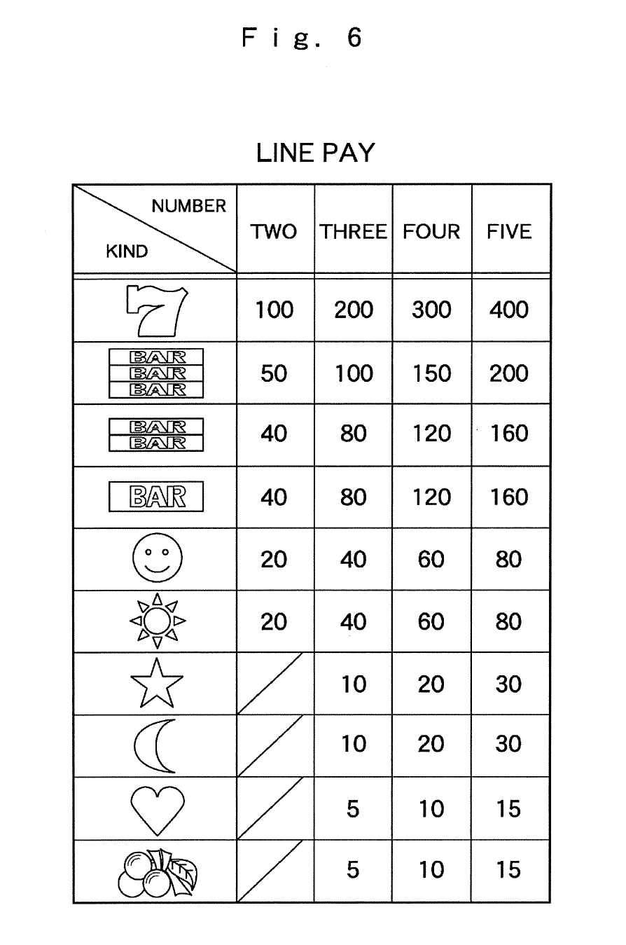

FIG. 5 is a front view showing paylines A through E set in the slot machine of this embodiment;

FIG. 6 is a diagram showing a list of symbols and prizes to be used in the slot machine of this embodiment;

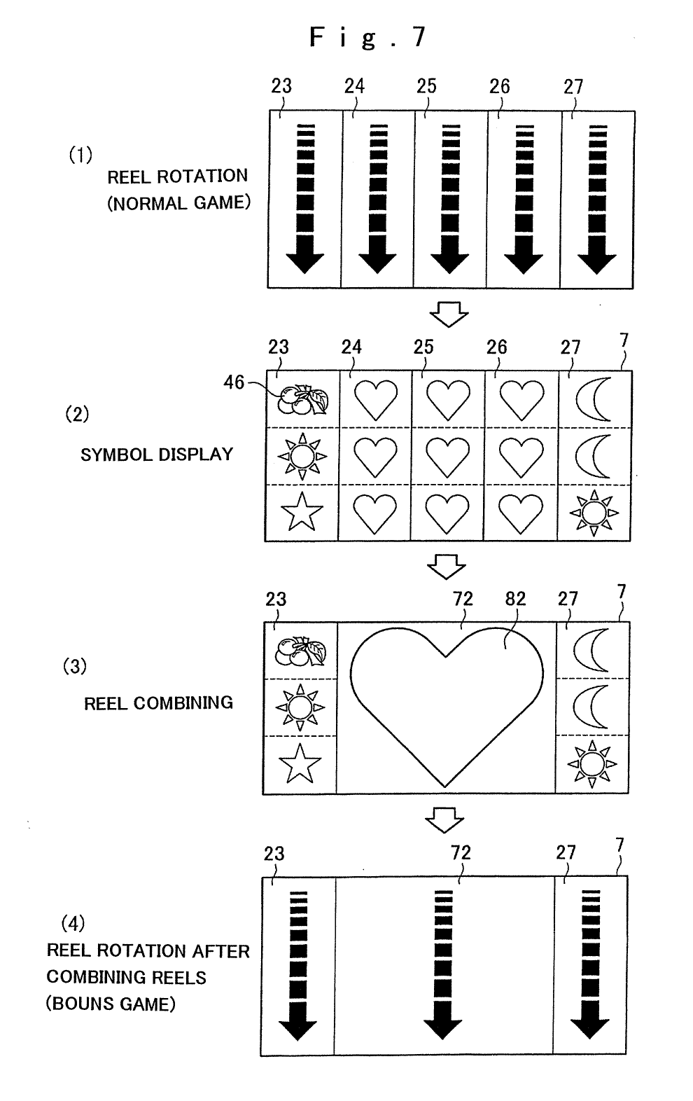

FIG. 7 are drawings showing an example of a combining pattern of reels in the slot machine of this embodiment;

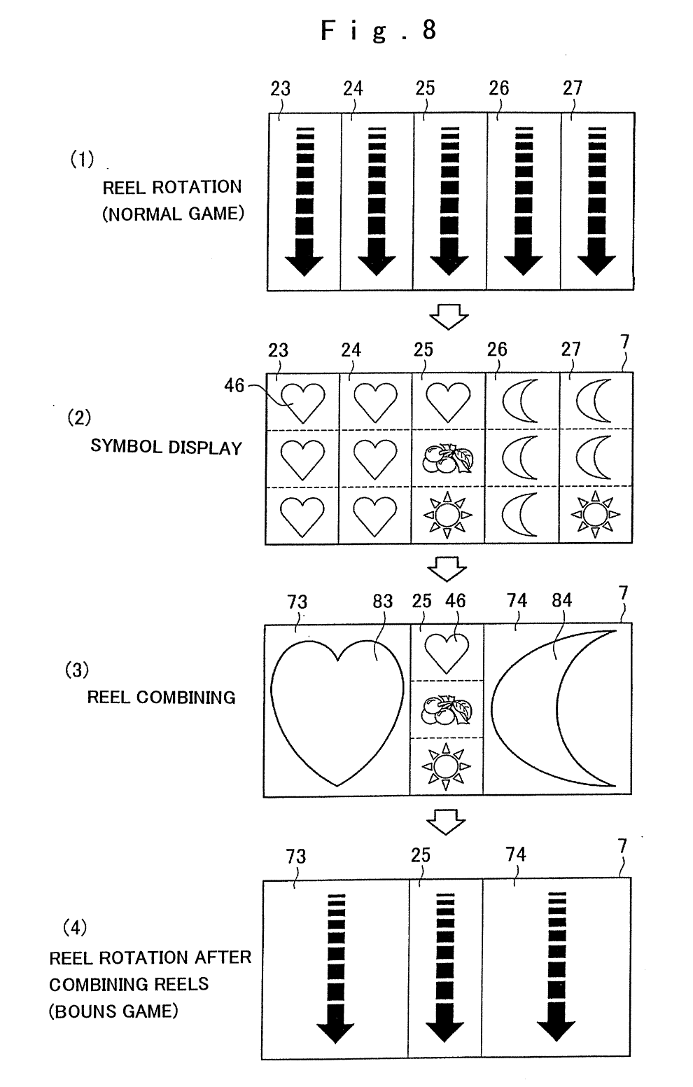

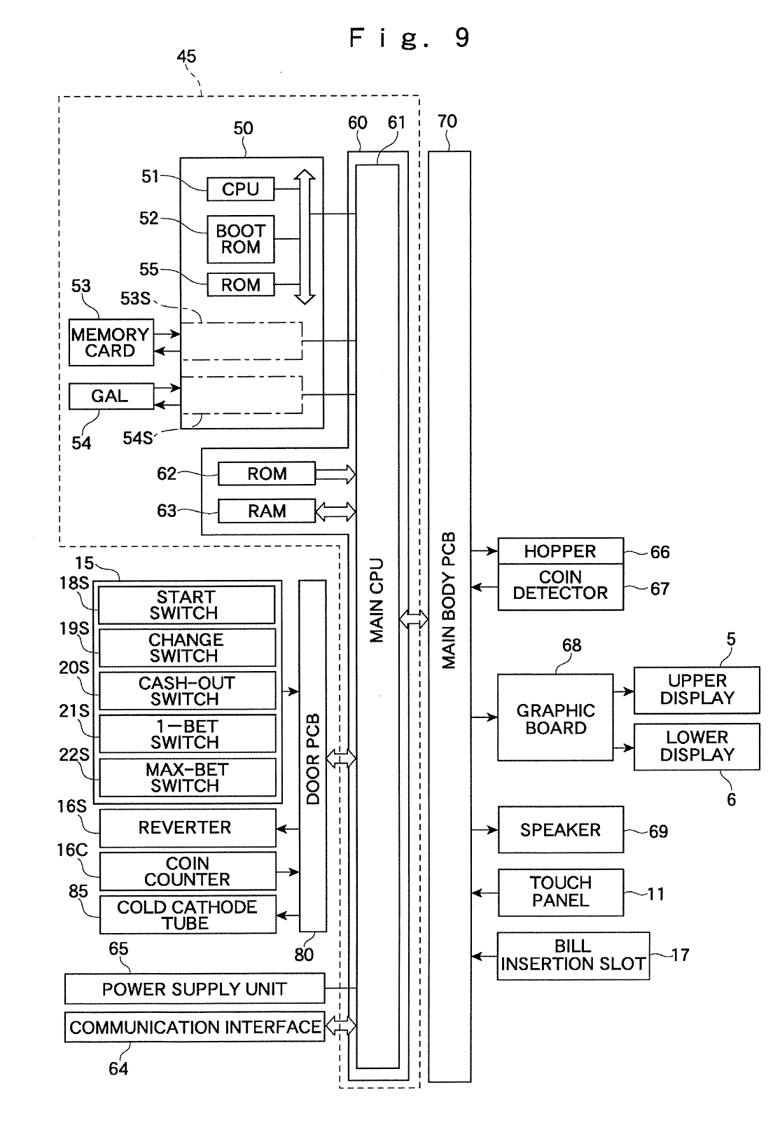

FIG. 8 are drawings showing an example of a combining pattern of reels in the slot machine of this embodiment;

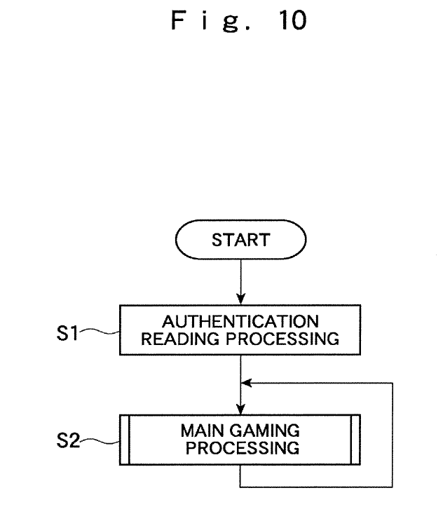

FIG. 9 is a block diagram schematically showing a control system of the slot machine of this embodiment;

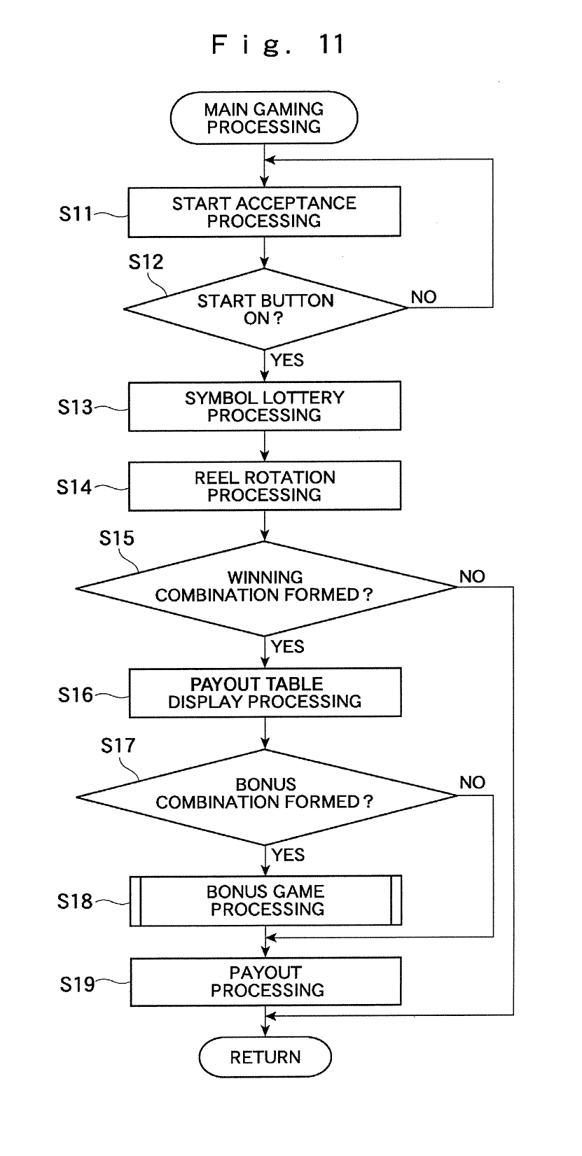

FIG. 10 is a flowchart of a main control processing program in the slot machine of this embodiment;

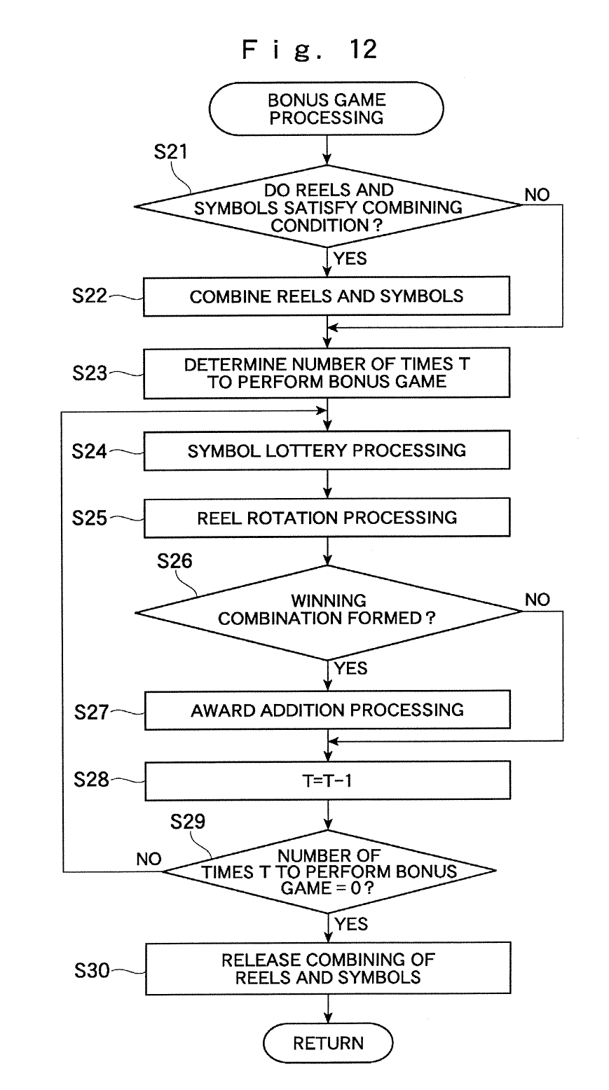

FIG. 11 is a flowchart of the main control processing program in the slot machine of this embodiment; and

FIG. 12 is a flowchart of a bonus game processing program in the slot machine of this embodiment.

### DESCRIPTION OF THE PREFERRED EMBODIMENTS

A slot machine (for example, slot machine 1) of the present embodiment includes: a controller (for example, controller 49) which controls game progress; symbol display areas (for example, symbol display areas 31 through 45) for displaying symbols; and a plurality of reels (for example, reels 23 through 27) which perform scrolling display of a plurality of symbols and stopping display of any one or a plurality of symbols in the symbol display areas, wherein the controller forms a new combined reel (for example, combined reels 71 through 74) by combining a plurality of reels adjacent to each other when a predetermined number or more of symbols of the same kind are stopped and displayed on the plurality of reels adjacent to each other, and scrolls and displays a plurality of symbols on a plurality of reels including the combined reel in a subsequent game.

According to the slot machine constructed as described above, when a predetermined number or more of symbols of the same kind are stopped and displayed on a plurality of reels adjacent to each other, a new combined reel is formed by combining the plurality of reels adjacent to each other, and in a subsequent game, a plurality of symbols are scrolled and displayed on a plurality of reels including the combined reel, so that by changing the number and sizes of reels according to the progress of the game, the entertainment of the slot machine can be improved while securing high visibility. In addition, according to the reduction in the number of reels, an apparent probability that symbols form a combination which causes a prize to be awarded is increased, and the expectation of the game is increased.

Furthermore, in the slot machine of this embodiment, when a new combined reel (for example, combined reel 71) is formed by combining the plurality of reels adjacent to each other, a new combined symbol (for example, combined symbols 81 through 84) can be formed by combining the predetermined number or more of symbols of the same kind stopped and displayed.

According to the slot machine constructed as described above, when a new combined reel is formed by combining the plurality of reels adjacent to each other, a new combined symbol is formed by combining the predetermined number or more of symbols of the same kind stopped and displayed, so that the entertainment of the slot machine can be improved while securing high visibility. In addition, by enlarging the symbol, an apparent probability that symbols form a combination which causes a prize to be awarded is increased, and the expectation of the game is increased.

Furthermore, in the slot machine of this embodiment, when a bonus game transfer condition is satisfied and a predetermined number or more of symbols of the same kind are stopped and displayed on a plurality of reels adjacent to each other, a new combined reel (for example, combined reels 71 through 74) can be formed by combining the plurality of reels adjacent to each other and a new combined symbol (for example, combined symbols 81 through 84) can be formed by combining the predetermined number or more of symbols of the same kind stopped and displayed, and in a subsequent bonus game, a plurality of symbols including the combined symbol can be scrolled and displayed on a plurality of reels including the combined reel.

According to the slot machine constructed as described above, when a bonus game transfer condition is satisfied and a predetermined number or more of symbols of the same kind are stopped and displayed on a plurality of reels adjacent to each other, a new combined reel is formed by combining the plurality of reels adjacent to each other, and a new combined symbol is formed by combining the predetermined number or more of symbols of the same kind stopped and displayed, and in a subsequent bonus game, a plurality of symbols including the combined symbol are scrolled and displayed on a plurality of reels including the combined reel, so that by changing the number and sizes of reels and the sizes of symbols according to the progress of the game, the entertainment of the slot machine can be improved while securing high visibility. In the bonus game, the number of reels is reduced and the symbol is enlarged, so that an apparent probability that the symbols form a combination which causes a prize to be awarded is increased and the expectation of the bonus game is increased.

Furthermore, in the slot machine of this embodiment, when a bonus game transfer condition is satisfied and a predetermined number or more of symbols of the same kind are stopped and displayed on a plurality of reels adjacent to each other, a new combined reel (for example, combined reels 71 through 74) can be formed by combining the plurality of reels adjacent to each other, and in a subsequent bonus game, a plurality of symbols can be scrolled and displayed on a plurality of reels including the combined reel.

According to the slot machine constructed as described above, when the bonus game transfer condition is satisfied and a predetermined number or more of symbols of the same kind are stopped and displayed on a plurality of reels adjacent to each other, a new combined reel (for example, combined reels 71 through 74) is formed by combining the plurality of reels adjacent to each other, and in a subsequent bonus game, a plurality of symbols can be scrolled and displayed on a plurality of reels including the combined reel, so that the number of reels is reduced in the bonus game, an apparent probability that the symbols form a combination which causes a prize to be awarded is increased and the expectation of the bonus game is increased.

Hereinafter, an embodiment of the slot machine of the present invention will be described with reference to the drawings. Herein, the slot machine of the embodiment described below is a so-called video slot machine which includes a display device such as a liquid crystal display and performs a game by displaying images of various symbols on the display device.

In the slot machine of the present invention, as a condition for awarding a prize, formation of a winning combination including a predetermined number or more (for example, five or more) of symbols of the same kind arranged along a payline of a display is set, however, in particular, when all reels stop rotating and symbols are displayed in the respective symbol display areas, in the case where the condition for transfer to a bonus game is satisfied and the predetermined number or more of symbols of the same kind are displayed on a plurality of reels adjacent to each other, anew combined reel is formed by combining the plurality of reels. Then, in a subsequent bonus game, symbols are arranged by the combined reel.

For example, FIG. 1 shows an example of application to a slot machine including five reels 23 through 27 on a display. When a game is started in the slot machine, as shown in FIG. 1(1), symbol rows are scrolled and displayed on the respective reels 23 through 27. Then, when a predetermined time elapses, the reels 23 through 27 stop rotating in order from the left, and as shown in FIG. 1(2), up to fifteen symbols 46 are displayed in the respective symbol display areas.

Herein, on the assumption that display of a predetermined number or more of symbols of the same kind on a plurality of reels adjacent to each other (five or more on two reels adjacent to each other, eight or more on three reels adjacent to each other, ten or more on four reels adjacent to each other, or thirteen or more on five reels adjacent to each other) are set as a condition for combining reels and symbols and a condition for transfer to a bonus game, after a predetermined number or more of symbols of the same kind are displayed on a plurality of reels adjacent to each other, the reels adjacent to each other are combined into one reel, and the process then transfers to a bonus game.

For example, in the example shown in FIG. 1, six “HEART” symbols are displayed on two reels 23 and 24 adjacent to each other, so that the corresponding reels 23 and 24 are combined to form a new combined reel 71 as shown in FIG. 1(3). At this time, on the combined reel 71, a combined “HEART” symbol 81 formed by combining “HEART” symbols stopped and displayed on the reels 23 and 24 is arranged. The combined symbol 81 is a symbol with a larger size enlarged to all symbol display areas of the reels 23 and 24 before being combined. Thereafter, as shown in FIG. 1(4), a bonus game is performed by scrolling and displaying symbol rows including the combined symbol 81 by using the combined reel 71 and the reels 25 through 27.

The condition for transfer to the bonus game may be another condition, and in this case, when the predetermined condition for transfer to the bonus game is satisfied and a predetermined number or more of symbols of the same kind are displayed on a plurality of reels adjacent to each other, reels and symbols are combined.

First, a general construction of a slot machine 1 of this embodiment will be described with reference to FIG. 2. FIG. 2 is an external perspective view of the slot machine 1 of this embodiment.

The slot machine 1 of this embodiment includes a cabinet 2, a top box 3 installed on the upper side of the cabinet 2, and a main door 4 provided on the front face of the cabinet 2.

On the front face of the top box 3, an upper display 5 is provided. Herein, the upper display 5 includes a generally known liquid crystal display, and displays a game method and a payout table.

On the other hand, on the entire surface of the main door 4, a lower display 6 is provided. Herein, the lower display 6 includes a generally known liquid crystal display, and has a symbol display unit 7 including up to 3×5 symbol display areas. The symbol display unit 7 includes five rows of reels 23 through 27 at the time of a normal game, and on each of the reels 23 through 27, a symbol row arranged as predetermined is scrolled and displayed, and after a predetermined time elapses, three symbols are stopped and displayed on each reel. Consequently, as described later, fifteen symbols are displayed according to the progress of the game, and based on a combination of the displayed symbols, a predetermined prize is awarded to a player. On the other hand, at the time of a bonus game, by combining reels, the number of reels is changed from that in the normal game (see FIG. 1), and by one through four reels including the combined reel, the symbol display unit 7 is constituted. The symbol rows are scrolled and displayed on the respective reels, and based on a combination of displayed symbols, a predetermined prize is awarded to the player.

The number of reels in the normal game may be three, and the number of symbols to be displayed is not limited to fifteen.

On the front face of the lower display 6, a touch panel 11 is provided, and a player can input various instructions by operating the touch panel 11.

Furthermore, on the lower display 6, a credit number display unit 8 and a payout number display unit 9 are provided. On the credit number display unit 8, the number of credits that the player currently has is displayed. On the payout number display unit 9, an amount of a prize to be awarded when the combination of symbols stopped and displayed on a symbol display unit 7 is a predetermined winning combination is displayed as a payout number.

At the lower side of the lower display 6, a control panel 15 on which a plurality of buttons for inputting instructions relating to the game progress by a player are arranged, a coin receiving opening 16 for receiving coins as game media into the cabinet 2, and a bill insertion slot 17 are provided.

On the control panel 15, a start button 18, a change button 19, a CASH-OUT button 20, a 1-BET button 21, and a MAX-BET button 22 are provided. The start button 18 is an operating unit for inputting an instruction to start scrolling display of symbol rows on the reels 41 through 44. The change button 19 is an operating unit to be used for requesting staff of a game arcade to change money. The CASH-OUT button 20 is an operating unit for inputting an instruction to pay-out coins corresponding to the number of credits that the player has (one credit corresponds to one coin) from a coin payout opening 28 to a coin tray 29, or an instruction to pay-out a barcode ticket.

The 1-BET button 21 is an operating unit for accepting an instruction to bet one credit for a game among the credits that the player has. The MAX-BET button 2 is an operating unit for accepting an instruction to bet the maximum number of credits that can be bet for one game (in this embodiment, 50 credits) of the credits that the player has for the game. As BET buttons, various BET buttons such as a 3-BET button can be additionally provided.

In the slot machine 1 of this embodiment, as game media, coins, bills, or electronic value information (credits) corresponding to the coins and bills are used. However, game media applicable to the present invention are not limited to these, and for example, medals, tokens, electronic money, and tickets, etc., can also be used.

Subsequently, based on FIG. 1, FIG. 3, and FIG. 6, the symbol display unit 7 of the lower display 6 and symbols to be displayed on the symbol display unit 7 will be distinctively described in the case of a normal game and in the case of a bonus game. FIG. 3 is a front view showing the symbol display unit 7 in the case of a normal game of the slot machine of this embodiment, and FIG. 4 is a front view showing the symbol display unit 7 in the case of a bonus game of the slot machine of this embodiment. FIG. 5 is a front view of paylines A through E to be set in the slot machine 1 of this embodiment, and FIG. 6 is a diagram showing symbols and contents of prizes to be used in the slot machine 1 of this embodiment.

First, the symbol display unit 7 and symbols to be displayed on the symbol display unit 7 when executing a normal game will be described. In the normal game, the symbol display unit 7 of this embodiment includes five rows of reels 23 through 27. The reels 23 through 27 respectively have symbol display areas 31 through 45 for displaying three symbols each on the reels 23 through 27 when the reels are stopped rotating. Then, when a game is started, as shown in FIG. 1(1) and FIG. 1(2), each symbol (a total of fifteen symbols) is displayed in the respective symbol display areas 31 through 45. For distinguishing the symbol display areas 31 through 45, in the drawings, these are divided by dotted lines, however, these dotted lines may not be displayed.

Herein, symbols to be used in a normal game in the slot machine 1 of this embodiment includes 10 kinds of symbols 46 and blanks (blank symbols) shown in FIG. 6.

In the slot machine 1 of this embodiment, when a winning combination including a predetermined number or more of symbols 46 of the same kind arranged along the preset five paylines A through E shown in FIG. 5 is formed, a prize is awarded. When a bonus combination including a predetermined number or more of symbols of the same kind arranged on a plurality of reels adjacent to each other (five or more on two reels adjacent to each other, eight or more on three reels adjacent to each other, ten or more on four reels adjacent to each other, or thirteen or more on five reels adjacent to each other) is formed, a bonus game is executed as a prize continuously after the normal game is finished.

Next, the symbol display unit 7 and symbols to be displayed on the symbol display unit 7 when executing a bonus game will be described. In the bonus game, the symbol display unit 7 of this embodiment includes one through four rows of reels including a combined reel. Herein, the number of reels in the bonus game is determined according to the pattern of the bonus combination. That is, when transferring from the normal game to the bonus game, the plurality of reels on which a predetermined number or more of symbols 46 of the same kind in the bonus combination are arranged are combined and replaced by a new combined reel, so that when two reels are combined, as shown in FIG. 1, the symbol display unit 7 is constituted by a total of four rows of reels. As shown in FIG. 7, when three reels are combined, the symbol display unit 7 is constituted by a total of three rows of reels, when four reels are combined, the symbol display unit 7 is constituted by a total of two rows of reels, and when five reels are combined, the symbol display unit 7 is constituted by a total of one row of reel. As shown in FIG. 8, there is a case where two or more combinations of reels are simultaneously combined.

Each of reels which have not been combined has symbol display areas for displaying three symbols each when the rotation thereof is stopped. On the other hand, the combined reel has a symbol display area for displaying one combined symbol thereon when the rotation thereof is stopped. For example, FIG. 4 shows the symbol display unit 7 when the reel 23 and the reel 24 are combined. In the symbol display unit 7 shown in FIG. 4, a combined reel 71 is formed by combining the reel 23 and the reel 24. On the symbol display area 47, a combined symbol 81 (see FIG. 1) formed by combining symbols 46 displayed on the symbol display areas 31 through 36 is scrolled and displayed, and the combined symbol 81 or a blank symbol is stopped and displayed. As a result, when the combined symbol 81 is displayed in the symbol display area 47, a prize to be awarded is determined by regarding that symbols 46 of the same kind as of the combined symbol 81 have been displayed on all symbol display areas 31 through 36 before the reels are combined. The reels 25 through 27 other than the combined reel 71 are controlled in the same manner as in the normal game.

In this embodiment, when a predetermined number of symbols of the same kind are displayed along the payline shown in FIG. 5 (however, if the combined symbol is displayed in the bonus game, it is regarded that symbols 46 of the same kind are displayed in all original symbol display areas constituting the display area of the combined symbol), winning is judged, and a prize is awarded, however, it is also allowed that, regardless of the payline, when a predetermined number or more of symbols 46 of the same kind are arranged on the symbol display areas 31 through 45, winning is judged, and a prize is awarded. It is also allowed that both of a prize based on the payline and a prize that is not based on the payline are paid out.

Subsequently, game proceeding procedures of the slot machine 1 of this embodiment will be described in detail. First, after bet acceptance is finished, when the start button 18 is depressed, lottery processing for selecting symbols to be arranged on the symbol display unit 7 by lottery is executed. Next, when a predetermined time elapses since the depression of the start button 18, the reels 23 through 27 start rotating and perform scrolling display of symbol rows, and after a predetermined time elapses, a total of fifteen symbols 46 are stopped and displayed on the symbol display areas 31 through 45 in a phased manner. Then, when a predetermined number or more of symbols of the same kind are displayed on a plurality of reels adjacent to each other among the reels 23 through 27 (five or more on two reels adjacent to each other, eight or more on three reels, ten or more on four reels, or thirteen or more on five reels), the reels adjacent to each other are combined to form one combined reel, and the game transfers to a bonus game. In the bonus game, the combined symbol is scrolled and displayed on the combined reel, and based on the combination of symbols 46 including the combined symbol, contents of a prize are determined and the prize is awarded.

Herein, for example, in an example shown in FIG. 7, nine “HEART” symbols are displayed on the three reels 24 through 26 adjacent to each other, so that as shown in FIG. 7(3), the corresponding reels 24 through 26 are combined to form a new combined reel 72. At this time, on the combined reel 72, a combined “HEART” symbol 82 formed by combining the “HEART” symbols stopped and displayed on the reels 24 through 26 is arranged. The combined symbol 82 is a large-sized symbol enlarged to all symbol display areas of the respective reels 24 through 26 before being combined. Thereafter, as shown in FIG. 7(4), a bonus game is performed by performing scrolling display of the symbol rows including the combined symbol 82 by using the combined reel 72 and the reels 23 and 27.

In an example shown in FIG. 8, six “HEART” symbols are displayed on the two reels 23 and 24 adjacent to each other, and five “MOON” symbols are displayed on the two reels 26 and 27 adjacent to each other, so that as shown in FIG. 8(3), the corresponding reels 23 and 24 and the corresponding reels 26 and 27 are combined, respectively, to form new combined reels 73 and 74. At this time, on the combined reel 73, a combined “HEART” symbol 83 formed by combining the “HEART” symbols stopped and displayed on the reels 23 and 24 is arranged, and on the combined reel 74, a combined “MOON” symbol 84 formed by combining the “MOON” symbols stopped and displayed on the reels 26 and 27 is arranged. The combined symbol 83 is a large-sized symbol enlarged to all symbol display areas of the respective reels 23 and 24 before being combined, and the combined symbol 84 is a large-sized symbol enlarged to all symbol display areas of the reels 26 and 27 before being combined. Thereafter, as shown in FIG. 8(4), a bonus game is performed by performing scrolling display of symbol rows including the combined symbols 83 and 84 by using the combined reels 73 and 74 and the reel 25.

Next, a construction of a control system of the slot machine 1 of this embodiment will be described based on FIG. 9. FIG. 9 is a block diagram schematically showing the control system of the slot machine 1 of this embodiment.

As show in FIG. 9, the control system of the slot machine 1 basically includes a mother board 60 and a gaming board 50. The motherboard 60 and the gaming board 50 constitute a controller 49 which executes the control program described later (FIG. 10 through FIG. 12), etc.

First, the gaming board 50 is described. The gaming board 50 includes a CPU 51, a ROM 55, and a boot ROM 52 connected to each other by internal buses, a card slot 53S for a memory card 53, and an IC socket 54S for a GAL (Generic Array Logic) 54.

The memory card 53 includes a non-volatile memory, and is a recording medium on which a game program and a game system program (hereinafter, referred to as a game program, etc.) are recorded. The game program recorded on the memory card 53 includes a lottery program. This lottery program is for determining symbols to be displayed in the symbol display areas 31 through 45 and determining symbols to be displayed in the respective symbol display areas (symbol display areas 34 through 45 and 47 in FIG. 4) including a symbol display area of a combined reel.

The memory card 53 includes a symbol sortition table for selecting symbols to be displayed in the symbol display areas by lottery. Herein, the symbol sortition table is a table in which predetermined random number ranges are associated with the ten kinds of symbols 46 and blanks to be stopped and displayed in the respective symbol display areas. First, symbols 46 and a combined symbol to be stopped and displayed in the symbol display areas are selected by lottery based on the symbol sortition table, and thereafter, based on the combination of the determined symbols 46 and combined symbol, a prize to be awarded to a player is determined.

As the symbol sortition table, a table which associates predetermined random number ranges with prizes to be awarded to the player may be used. In this case, first, a prize to be awarded to a player is selected by lottery based on the symbol sortition table, and then a combination of the symbols 46 and the combined symbol that correspond to the determined prize are selected by the main CPU 61.

Subsequently, the mother board 60 will be described. The mother board 60 is formed of a general-purpose mother board available on the market (a printed circuit board on which basic components of a personal computer are mounted), and includes a main CPU 61, a ROM 62, a RAM 63, and a communication interface 64.

The ROM 62 includes a memory device such as a flash memory and stores permanent data such as programs of BIOS, etc., to be executed by the main CPU 61. When the BIOS is executed by the main CPU 61, predetermined peripheral devices are initialized, and import processing of the game program, etc., stored in the memory card 53 is started via the gaming board 50.

The RAM 63 stores data and programs to be used when the main CPU 61 operates. In addition, the RAM 63 can store various programs such as an authentication program and the game program, etc., to be read out via the gaming board 50, and various information such as the number of credits that the player currently has.

The communication interface 64 is a communication device for communicating with a server, etc., installed in the game arcade via a communication line.

To the mother board 60, a main body PCB 70 and a door PCB 80 described later are connected by USB, respectively. Furthermore, to the mother board 60, a power supply unit 65 is connected. When power is supplied to the mother board 60 from the power supply unit 65, the main CPU 61 of the mother board 60 is started. Furthermore, power is supplied to the gaming board 50 via a PCI bus and the CPU 51 is started.

To the main body PCB 70, a hopper 66, a coin detector 67, a graphic board 68, a speaker 69, a touch panel 11, and a bill insertion slot 17, etc., are connected.

The graphic board 68 controls image display on the upper display 5 and the lower display 6 based on a control signal from the main CPU 61. For example, on the upper display 5, a payout table and a help screen are displayed, and on the lower display 6, scrolling display and stopping display of symbols 46 along with the rotations of the reels 23 through 27 in a normal game are performed on the symbol display unit 7. When a predetermined condition is satisfied after symbols 46 are stopped and displayed in a normal game, the reels and symbols are combined (see FIG. 1). Then, in a bonus game, scrolling display and stopping display of a combined symbol and symbols are performed along with the rotations of the one through four rows of reels including the combined reel. When the bonus game is finished, the combining is released.

On the other hand, to the door PCB 80, a control panel 15, a reverter 16S, a coin counter 16C, and a cold cathode tube 85 are connected. On the control panel 15, a start switch 18S respondent to the start button 18, a change switch 19S respondent to the change button 19, a CASH-OUT switch 20S respondent to the CASH-OUT button 20, a 1-BET switch 21S respondent to the 1-BET button 21, and a MAX-BET switch 22S respondent to the MAX-BET button 22 are provided. Each switch outputs an input signal to the main CPU 61 when a corresponding button is operated by a player.

Subsequently, a main control program to be executed in the slot machine 1 of this embodiment will be described in detail with reference to the drawings. FIG. 10 is a flowchart of the main control program.

It is assumed that, in the slot machine 1, the memory card 53 has been inserted into the card slot 53S of the gaming board 50 and the GAL 54 has been attached to the IC socket 54S.

First, when the power supply switch of the power supply unit 65 is turned on (power is applied), the mother board 60 and the gaming board 50 are started, respectively, and authentication reading processing of Step (hereinafter, abbreviated to S) 1 is executed. In this authentication reading processing, the mother board 60 and the gaming board 50 perform processings different from each other, concurrently.

That is, in the gaming board 50, the CPU 51 reads-out a preliminary authentication program stored in the boot ROM 52, and according to the readout preliminary authentication program, performs preliminary authentication to confirm and prove that the authentication program has not been falsified before importing the same into the mother board 60.

On the other hand, in the mother board 60, the main CPU 61 develops compressed data installed in the BIOS into the RAM 63 by executing the BIOS stored in the ROM 62, and executes the BIOS developed in the RAM 63 and diagnoses and initializes various peripheral devices.

Thereafter, the main CPU 61 reads-out the authentication program stored in the ROM 55, and performs authentication to confirm and prove that the game program, etc., stored in the memory card 53 inserted in the card slot 53S has not been falsified. When this authentication processing is normally finished, the main CPU 61 writes the game program, etc., that have been subjected to authentication (have been authenticated) on the RAM 63. Subsequently, the CPU performs import processing for reading-out payout ratio setting data stored in the GAL 54 via the gaming board 50, and writes the readout payout ratio setting data on the RAM 63.

After performing the above-described processings, the main CPU 61 ends the authentication reading processing.

Then, at S2, the main CPU 61 successively reads-out the game program, etc., authenticated in the authentication reading processing of S1 from the RAM 63 and executes them, and performs main gaming processing. By executing this main gaming processing, a game is performed in the slot machine 1 of this embodiment. The main gaming processing is then repeated during supply of the power to the slot machine 1.

Next, sub-processing of the main gaming processing of S2 will be described with reference to FIG. 11. FIG. 11 is a flowchart of a main gaming processing program in the slot machine 1 of this embodiment. Each program shown in the flowchart of FIG. 11 is stored in the memory card 53, and is developed in the RAM 63 of the controller 49 and executed by the main CPU 61.

First, as shown in FIG. 11, at S11, the CPU 61 performs predetermined initialization setting and then performs start acceptance processing for accepting coin insertion and setting the number of bets. At this time, in the initialization processing, processing such as clearing of data of items set in a predetermined data area (for example, a payout coin counter, etc.,) is performed. In the start acceptance processing, a player performs a bet operation for setting the number of bets in a current game to any of 1 to 50 bets by inserting coins or using the 1-BET button 21 or the MAX-BET button 22.

Next, at S12, the main CPU 61 judges whether the start button 18 has been input. It is judged whether the start button 18 has been input based on whether an input signal has been received from the start switch 18S.

Then, when the start button 18 is not input (S12: NO), the process returns to the start acceptance processing (S11) again. At this time, operations for correcting the number of bets, etc., can be performed. On the other hand, when the start button 18 is input (S12: YES), the number of bets set based on an operation on the 1-BET button 21 or the MAX-BET button 22 is subtracted from the number of credits that the player has and is stored in the RAM 63 as bet information.

Thereafter, at S13, the main CPU 61 executes symbol lottery processing for selecting symbols to be displayed in the respective symbol display areas 31 through 45 of the symbol display unit 7 by lottery. In detail, the main CPU 61 samples random numbers from predetermined random number ranges by executing a random number generating program included in the lottery program stored in the RAM 63, and based on the sampled random numbers and the symbol sortition table, determines fifteen symbols to be displayed in the symbol display areas 31 through 45 (that is, stop positions of the reels 23 through 27) among the 10 kinds of symbols.

Furthermore, at S14, the main CPU 61 starts rotating the reels 23 through 27, and performs scrolling display of symbol rows arranged on the respective reels 23 through 27 at a predetermined speed. Thereafter, when a predetermined time elapses, the rotations of the reels 23 through 27 are stopped in a predetermined order from the left, and one symbol is displayed each on the reels 23 through 27 (see FIG. 1, FIG. 7, and FIG. 8).

Subsequently, at S15, the main CPU 61 judges whether the combination of symbols 46 displayed in the symbol display areas 31 through 45 is a winning combination which causes a certain prize to be awarded.

As a result, when it is judged as a winning combination (S15: YES), the process transfers to S16. On the other hand, when it is not judged as a winning combination (S15: NO), the main gaming processing is ended. In order to continuously start a next game, the processings of S1 and subsequent steps are performed again.

At S16, the main CPU 61 notifies the player of contents of the prize by displaying the contents of the prize based on the winning combination formed on the lower display 6. For example, when the number of bets is one and five “CHERRY” symbols are displayed along the payline, the letters “Win 15” which notify that 15 credits are awarded as a prize are displayed.

Subsequently, at S17, it is judged whether a bonus combination is formed by the combination of the symbols displayed in the symbol display areas 31 through 45 by the reel rotation processing of S14. Herein, the bonus combination is a combination including a predetermined number or more of symbols of the same kind arranged on a plurality of reels adjacent to each other (five or more on two reels adjacent to each other, eight or more on three reels adjacent to each other, ten or more on four reels adjacent to each other, or thirteen or more on five reels adjacent to each other).

As a result, when it is judged that the bonus combination has been formed (S17: YES), the process transfers to bonus game processing (S18). The bonus game processing will be described in detail later with reference to FIG. 12. On the other hand, when it is judged that the bonus combination has not been formed (S17: NO), the process transfers to S19.

Then, at S19, the main CPU 61 pays out a prize based on the combination of the displayed symbols to the player. At this time, by depressing the CASH-OUT button 20, coins corresponding to the number of credits (one credit corresponds to one coin) can be paid out, or a ticket with a barcode can be paid out.

Next, sub-processing of the bonus game processing of S18 will be described with reference to FIG. 12. FIG. 12 is a flowchart of a bonus game processing program in the slot machine 1 of this embodiment. Each program shown in the flowchart of FIG. 12 is stored in the memory card 53, and is developed in the RAM 63 of the controller 49 and executed by the main CPU 61.

First, as shown in FIG. 12, at S21, in the main CPU 61, it is judged whether a predetermined condition for combining reels and symbols has been satisfied. Herein, a predetermined condition is that symbols 46 are stopped and displayed in a combination including a predetermined number or more of symbols of the same kind arranged on a plurality of reels adjacent to each other (five or more on two reels adjacent to each other, eight or more on three reels adjacent to each other, ten or more on four reels adjacent to each other, or thirteen or more on five reels adjacent to each other). In the slot machine 1 of this embodiment, this condition is the same as the bonus game transfer condition, so that when the game transfers to the bonus game, the predetermined condition for combining reels and symbols is always satisfied, however, when the condition for combining reels and symbols is made different from the bonus game transfer condition, the bonus game may be performed without combining reels and symbols.

When it is judged that the predetermined condition has been satisfied (S21: YES), the plurality of reels adjacent to each other are combined at S22 to form a new combined reel. Furthermore, the symbols 46 of the same kind displayed on the plurality of reels adjacent to each other are combined to form a new combined symbol (see FIG. 1, FIG. 7 and FIG. 8). On the other hand, when it is judged that the predetermined condition is not satisfied (S21: NO), the process transfers to S23 without combining the reels and symbols.

At S23, the main CPU 61 determines the number of times T to perform the bonus game in the current bonus game among five to twenty times by lottery, and stores the determined number of times T to perform the bonus game in the RAM 63.

Thereafter, at S24, the main CPU 61 executes symbol lottery processing of the bonus game to select symbols to be displayed in the respective symbol display areas of the symbol display unit 7 by lottery. In detail, the main CPU 61 samples random numbers from predetermined random number ranges by executing a random number generating program included in the lottery program stored in the RAM 63, and based on the sampled random numbers and the symbol sortition table, determines symbols to be displayed in the symbol display areas of the reels except for the combined reel (that is, stop positions of the reels except for the combined reel) among ten kinds of symbols. For the combined reel, it is determined which of the combined symbol and a blank is to be displayed.

Furthermore, at S25, the main CPU 61 starts rotating the reels including the combined reel, and performs scrolling display of symbol rows arranged on the reels at a predetermined speed. Thereafter, after a predetermined time elapses, the rotations of the reels are stopped in order from the left, and one symbol is displayed each in the respective symbol display areas.

Subsequently, at S26, the main CPU 61 judges whether the combination of the symbols 46 displayed in the respective symbol display areas is a winning combination which causes a certain prize to be awarded. Herein, when a combined symbol is displayed in the symbol display area of the combined reel, a winning combination is judged by regarding that symbols 46 of the same kind as the combined symbol have been displayed in all symbol display areas of the reels before being combined (for example, in FIG. 1(4), a winning combination is judged by regarding that “HEART” symbols 46 have been stopped and displayed in the symbol display areas 31 through 36).

As a result, when it is judged as a winning combination (S26: YES), an award amount based on the formed winning combination is accumulatively added until the bonus game is finished (S27). The award amount added at S27 is paid out as a prize together with the prize of the normal game in the payout processing of S19. On the other hand, when it is not judged as a winning combination (S26: NO), the process transfers to S28.

At S28, the main CPU 61 reads out the number of times T to perform the bonus game stored in the RAM and subtracts 1 therefrom. Then, the main CPU stores the resultant number of times T to perform the bonus game in the RAM 63 again.

Subsequently, at S29, the CPU 61 reads out the number of times T to perform the bonus game stored in the RAM and judges whether the number of times T to perform the bonus game is “0.” As a result, when it is judged that the number of times T to perform the bonus game is not “0” (S29: NO), the process returns to S24, and a bonus game is continuously performed. When it is judged that the number of times T to perform the bonus game is “0” (S29: YES), the main CPU releases the combining of the combined reel and the combined symbol which have been combined at S22, and restores the reels to the normal game state (S30). Thereafter, the bonus game is finished and the process transfers to S19.

As described above, in the slot machine 1 of this embodiment, when starting a game, the number of bets in a current game bet by a player's operation by using the 1-BET button 21 or the MAX-BET button 22 is accepted as any of 1 to 50 bets (S11), and thereafter, in the normal game, the reels 23 through 27 start rotating, and after a predetermined time elapses, a total of fifteen symbols 46 are stopped and displayed in the symbol display areas 31 through 45 (S14). At this time, when the bonus game transfer condition is satisfied and a combination including a predetermined number or more of symbols of the same kind arranged on a plurality of reels adjacent to each other is formed (S21: YES), the plurality of reels adjacent to each other are combined to form a new combined reel, and the symbols 46 of the same kind displayed on the plurality of reels adjacent to each other are combined to form a new combined symbol (S22). Then, in a subsequent bonus game, a plurality of symbols including the combined symbol are scrolled and displayed on a plurality of reels including the combined reel (S25), so that by changing the number and sizes of reels according to the progress of the game, the entertainment of the slot machine can be improved while securing high visibility. In the bonus game, the number of reels is reduced and the symbol is enlarged, so that an apparent probability that a winning combination is formed is increased, and the expectation of the bonus game is increased.

The present invention is not limited to the above-described embodiment, and of course, the present invention can be altered and varied in various ways without departing from the spirit of the invention.

For example, in this embodiment, the condition for transfer to the bonus game is that a combination including a predetermined number or more of symbols of the same kind arranged on a plurality of reels adjacent to each other (five or more on two reels adjacent to each other, eight or more on three reels adjacent to each other, ten or more on four reels adjacent to each other, or thirteen or more on five reels adjacent to each other) is formed, however, other conditions may be set as the condition for transfer to the bonus game. For example, a predetermined number or more of “7” symbols are stopped and displayed regardless of the reels, or the bonus game suddenly may arise as a mystery. In this case, reels and symbols may not be combined in the bonus game.

The reels and symbols may be combined not only in the bonus game but also in the normal game. In this case, it is desirable that when a predetermined number of games (for example, 10 games) have been finished since the reels are combined, the combined reel is released.

In this embodiment, the condition for combining reels and symbols is that a combination including a predetermined number or more of symbols of the same kind arranged on a plurality of reels adjacent to each other (five or more on two reels adjacent to each other, eight or more on three reels adjacent to each other, ten or more on four reels adjacent to each other, or thirteen or more on five reels adjacent to each other) is formed, however, a condition that a maximum allowable number of symbols of the same kind are displayed on a plurality of reels adjacent to each other (six symbols on two reels adjacent to each other, nine symbols on three reels adjacent to each other, twelve symbols on four reels adjacent to each other, or fifteen symbols on five reels adjacent to each other) may be set.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A slot machine comprising:
a controller which controls game progress;
symbol display areas for displaying symbols; and
a plurality of reels which perform scrolling display of a plurality of symbols and stopping display of any one or a plurality of symbols in the symbol display areas, wherein
the controller
forms a new combined reel by combining a plurality of reels adjacent to each other when a predetermined number or more of symbols of the same kind are stopped and displayed on the plurality of reels adjacent to each other, and
scrolls and displays a plurality of symbols on a plurality of reels including the combined reel in a subsequent game.

2. A slot machine comprising:
a controller which controls game progress;
symbol display areas for displaying symbols; and
a plurality of reels which perform scrolling display of a plurality of symbols and stopping display of any one or a plurality of symbols in the symbol display areas, wherein
the controller
forms a new combined reel by combining a plurality of reels adjacent to each other when a predetermined number or more of symbols of the same kind are stopped and displayed on the plurality of reels adjacent to each other,
forms a new combined symbol by combining the predetermined number or more of symbols of the same kind stopped and displayed, and
scrolls and displays a plurality of symbols including the combined symbol on a plurality of reels including the combined reel in a subsequent game.

3. A slot machine comprising:
a controller which controls game progress;
symbol display areas for displaying symbols; and
a plurality of reels which perform scrolling display of a plurality of symbols and stopping display of any one or a plurality of symbols in the symbol display areas, wherein
the controller
executes a bonus game continuously from a normal game when a predetermined bonus game transfer condition is satisfied,
forms a new combined reel by combining a plurality of reels adjacent to each other when the bonus game transfer condition is satisfied and a predetermined number or more of symbols of the same kind are stopped and displayed on the plurality of reels adjacent to each other,
forms a new combined symbol by combining the predetermined number or more of symbols of the same kind stopped and displayed, and
scrolls and displays a plurality of symbols including the combined symbol on a plurality of reels including the combined reel in a subsequent game.

4. The slot machine according to claim 1, wherein
the controller
executes a bonus game continuously from a normal game when a predetermined bonus game transfer condition is satisfied,
forms a new combined reel by combining a plurality of reels adjacent to each other when the bonus game transfer condition is satisfied and a predetermined number or more of symbols of the same kind are stopped and displayed on the plurality of reels adjacent to each other, and
scrolls and displays a plurality of symbols on a plurality of reels including the combined reel in a subsequent bonus game.
